(19) United States
(12) Patent Application Publication
(10) Pub. No.: US 2026/0087673 A1
(43) Pub. Date: Mar. 26, 2026

(54) Non-Repetitive Scanning Solid State LiDAR and Camera Extrinsic Calibration

(71) Applicant: Niantic Spatial, Inc., San Francisco, CA (US)

(72) Inventors: David Zuñiga-Noël, London (GB); Christopher Joseph Shaw, Bury (GB); Victor Adrian Prisacariu, Oxford (GB)

(21) Appl. No.: 19/337,789

(22) Filed: Sep. 23, 2025

Related U.S. Application Data
(60) Provisional application No. 63/697,950, filed on Sep. 23, 2024.

(51) Int. Cl. G06T 7/80; G01S 7/481; G01S 7/497; G01S 17/89

(52) U.S. Cl. CPC G06T 7/85; G01S 7/4817; G01S 7/497; G01S 17/89; G06T 2207/10012; G06T 2207/10028; G06T 2207/30244

(57) ABSTRACT

A system performs pose calibration between a LiDAR sensor and a camera. The system may receive an image frame captured by the camera mounted on a device. The system may receive a point cloud captured by the LiDAR sensor mounted on the device, the LiDAR sensor having an overlapping field of view with the camera. The system may identify markers of a calibration target captured in the image frame by applying a feature identification model to the image frame. The system may identify the markers of the calibration target captured in the point cloud by: clustering points in the point cloud into one or more planes, selecting one of the planes based on sizes of the planes; and identifying holes in the selected plane as the markers of the calibration target. The system may determine a pose transformation between the camera and the LiDAR sensor based on information identifying the markers from the image frame and information identifying the markers from the point cloud.

### CROSS-REFERENCE TO RELATED APPLICATION

This application claims the benefit of and priority to U.S. Provisional Application No. 63/697,950 filed on Sep. 23, 2024, which is incorporated by reference.

### BACKGROUND

The application relates to the technical field of computer vision.

In computer vision technologies, systems typically leverage image data and light detection and ranging (LiDAR) data to identify objects in a real-world environment. Non-repetitive scanning (NRS) solid state LiDAR sensors are becoming increasingly popular due to their compact size, lower production costs, and ability to capture denser point clouds. However, these NRS solid state LiDAR sensors are prone to high noise and non-uniform point distribution, creating a challenge in LiDAR-camera extrinsic calibration.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for computer vision applications, according to one embodiment.

FIG. 4 is an example LiDAR-Camera system, according to one embodiment.

FIG. 5 is an example calibration target, i.e., for use in pose calibration of a LiDAR sensor and a camera, according to one embodiment.

FIG. 6A is a conceptual workflow describing pose calibration of a LiDAR sensor and a camera, according to one embodiment.

FIG. 6B is a continuation of the conceptual workflow describing the pose calibration of the LiDAR sensor and the camera shown in FIG. 6A, according to one embodiment.

FIG. 7 is a flowchart describing the process of pose calibration, according to one embodiment.

FIG. 8 is a general computing system, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where VPS-based pose verification is desirable. In addition, the inherent flexibility of computer-based systems allows for a great variety of possible configurations, combinations, and divisions of tasks and functionality between and among the components of the system.

Various embodiments relate to the context of a visual positioning service (VPS). A VPS determines the precise location of a user or device by analyzing visual data captured from the device's camera assembly. A localization model compares a target frame against a database of reference images or maps to predict the device's position and orientation in real-time. VPS technology offers enhanced location accuracy and context awareness compared to traditional global positioning system (GPS) reliant systems, particularly in indoor and urban environments where GPS signals may be weak or unavailable.

### Example Location-Based Parallel Reality Game

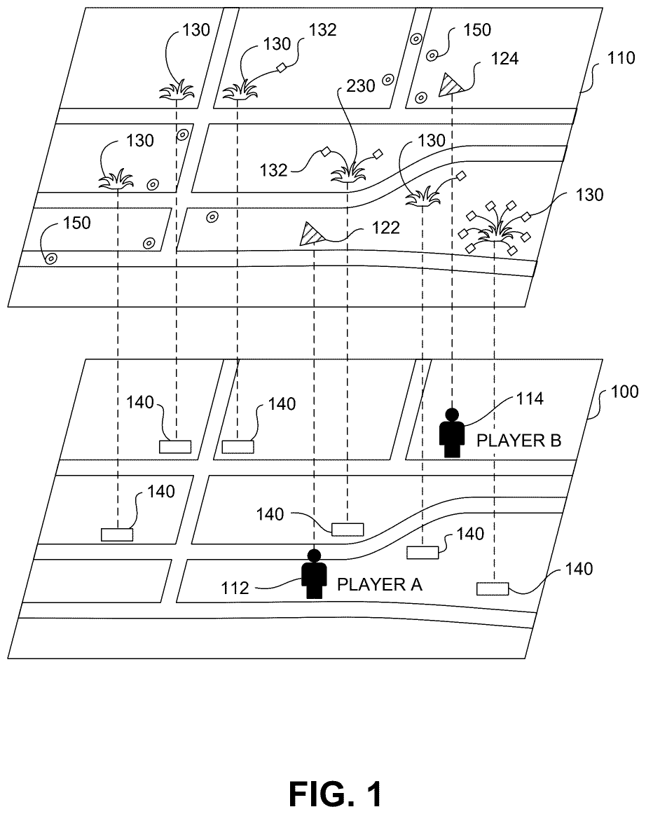

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

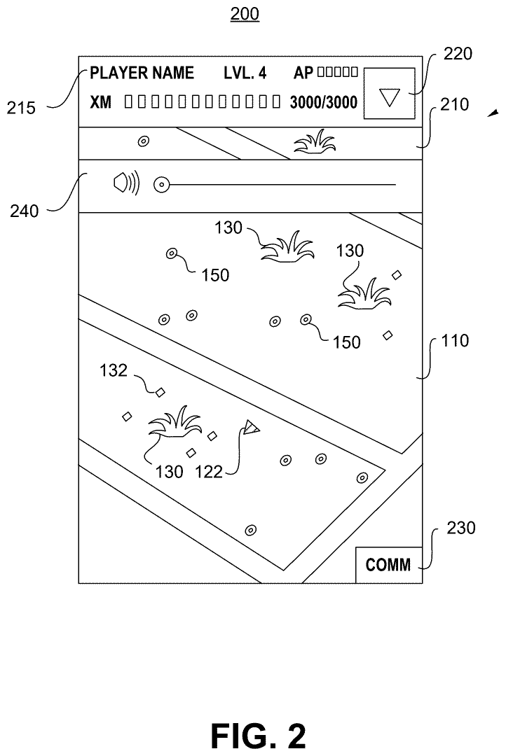

FIG. 2 depicts one or more embodiments of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a mobile device (e.g., a smart phone) and moving about in the real world with the mobile device. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

To generate the visual representation, a game server can generate and maintain a virtual map, e.g., that corresponds to the real-world environment. To generate the virtual map, the game server may collect image data from mobile devices of the physical environment. With the image data, the game server can create digital spatial models describing the physical environment. For example, the game server may leverage volumetric scene reconstruction algorithms to generate the spatial models from the image data (or pose data). In other embodiments, when generating virtual elements in an augmented reality context, the game server may perform localization to identify a pose of the mobile device. With the pose in hand, the game server can accurately identify positions to generate the virtual elements to augment the image data captured by the mobile device.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Online System

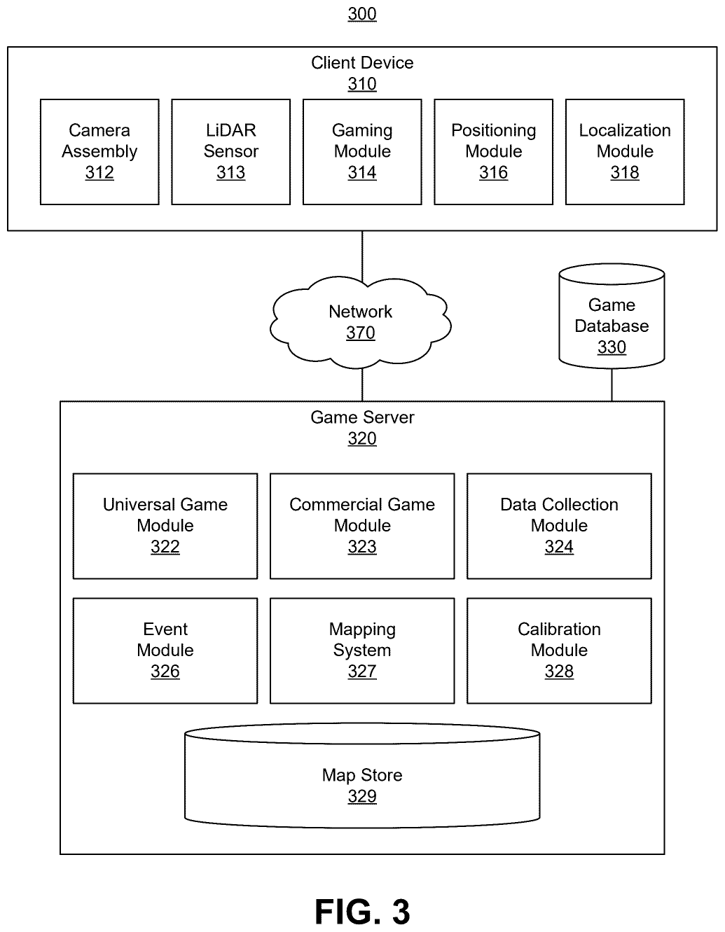

FIG. 3 illustrates one or more embodiments of a networked computing environment 300. The networked computing environment 300 uses a client-server architecture, where a server 320 communicates with a client device 310 over a network 370, e.g., to provide a parallel reality game to a user at the client device 310. The networked computing environment 300 also may include other external systems such as sponsor/advertiser systems or business systems. Although only one client device 310 is shown in FIG. 3, any number of client devices 310 or other external systems may be connected to the server 320 over the network 370. Furthermore, the networked computing environment 300 may contain different or additional elements and functionality may be distributed between the client device 310 and the server 320 in different manners than described below. In other embodiments, the networked computing environment 300 may be suitable for other computer-vision-based applications, e.g., providing augmented reality content, navigation of one or more autonomous vehicles, mapping a real-world environment, etc.

The networked computing environment 300 may provide for the interaction of users in a virtual world having a geography that parallels the real world. In particular, a geographic area in the real world can be linked or mapped directly to a corresponding area in the virtual world. A user can move about in the virtual world by moving to various geographic locations in the real world. For instance, a user's position in the real world can be tracked and used to update the user's position in the virtual world. Typically, the user's position in the real world is determined by finding the location of a client device 310 through which the user is interacting with the virtual world and assuming the user is at the same (or approximately the same) location. For example, in various embodiments, the user may interact with a virtual element if the user's location in the real world is within a threshold distance (e.g., ten meters, twenty meters, etc.) of the real-world location that corresponds to the virtual location of the virtual element in the virtual world. For convenience, various embodiments are described with reference to “the user's location” but one of skill in the art will appreciate that such references may refer to the location of the user's client device 310.

A client device 310 can be any portable computing device capable for use by a user to interface with the server 320. For instance, a client device 310 is preferably a portable wireless device that can be carried by a user, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the server 320 to provide sensory data of a physical environment. In one or more embodiments, the client device 310 includes a camera assembly 312, a non-repetitive scanning (NRS) solid state LiDAR sensor 313, a gaming module 314, a positioning module 316, and a localization module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The NRS solid state LiDAR sensor 313 captures depth information from light-based imaging. The NRS solid state LiDAR sensor 313 may include a light source, an optical modulator, a microelectromechanical system (MEMS) mirrors, one or more diffractive optical elements, a lens system, and a photodetector array. The light source generates and emits light pulses (e.g., in the form of laser) used in formulating the non-repetitive scanning pattern. The optical modulator controls the intensity or frequency of the light pulses. The MEMS mirrors tiny, movable mirrors can be used to adjust the direction of the light pulses. The diffractive optical elements may split the light pulses into multiple beams, each at a slightly different angle. The lens system focuses the non-repetitive scanning pattern into the real-world environment, and may also focus return light from the environment to the photodetector array. The photodetector array is an array of photodiodes for capturing light reflected off the real-world environment. The photodiodes may measure a time-of-flight to measure depth. Unlike traditional LiDAR sensors that use rotating mirrors to scan, this technology employs a solid-state design that eliminates mechanical components. This results in a smaller, more reliable, and potentially less expensive sensor. The non-repetitive scanning pattern, achieved through various optical techniques, empowers the NRS solid state LiDAR sensor 313 to capture depth data from a wider area.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.). The client device 310 may also be associated with one or more motor assemblies that can be actuated to cause movement of a vehicle, e.g., in autonomous navigation applications. In such embodiments, the client device 310 may include other modules for processing sensor data and determining control instructions for actuation of the motor assemblies based on the sensor data (and other contextual data that may be provided by the server 320).

In gaming embodiments, the gaming module 314 provides a user with an interface to participate in the parallel reality game. The server 320 transmits game data over the network 370 to the client device 310 for use by the gaming module 314 to provide a local version of the game to a user at locations remote from the game server. In one or more embodiments, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

In gaming embodiments, the gaming module 314 can also control various other outputs to allow a user to interact with the game without requiring the user to view a display screen. For instance, the gaming module 314 can control various audio, vibratory, or other notifications that allow the user to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation or proximity to cellular towers or Wi-Fi hotspots, or other suitable techniques.

As the user moves around with the client device 310 in the real world, the positioning module 316 tracks the position of the user and provides the user position information to the gaming module 314. The gaming module 314 updates the user position in the virtual world associated with the game based on the actual position of the user in the real world. Thus, a user can interact with the virtual world simply by carrying or transporting the client device 310 in the real world. In particular, the location of the user in the virtual world can correspond to the location of the user in the real world. The gaming module 314 can provide user position information to the server 320 over the network 370. In response, the server 320 may enact various techniques to verify the location of the client device 310 to prevent cheaters from spoofing their locations. It should be understood that location information associated with a user is utilized only if permission is granted after the user has been notified that location information of the user is to be accessed and how the location information is to be utilized in the context of the game (e.g., to update user position in the virtual world). In addition, any location information associated with users is stored and maintained in a manner to protect user privacy.

The localization module 318 provides an additional or alternative way to determine the location of the client device 310. In one or more embodiments, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the server 320. The 3D map may be a point cloud, mesh, or any other suitable 3D representation of the environment surrounding the client device 310. In some embodiments, the localization module 318 leverages an ensemble of image-based localization models that are laterally calibrated. In such embodiments, the localization module 318 may input image data into the ensemble of localization models to output poses for the image data. Based on the pose, the client device 310 may generate content for presentation to the user. Alternatively, in some embodiments, the localization module 318 may determine a location or pose of the client device 310 without reference to a coarse location (such as one provided by a GPS system), such as by determining the relative location of the client device 310 to another device.

In one or more embodiments, each localization model is configured to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly. In one or more embodiments, one or more of the localization models may be machine-learning models, trained with training datasets.

The server 320 includes one or more computing devices that interact with the client device 310, which may include data receipt from or data transmission to the client device 310, providing functionality to the client device 310, or other computer-based functionality. In gaming embodiments, the server 320 can include or be in communication with a game database 330. The game database 330 stores game data used in the parallel reality game to be served or provided to the client device 310 over the network 370. In other embodiments, the server 320 may include or be in communication with other databases for storage of data related to the computer-vision-based application.

In gaming embodiments, the game data stored in the game database 330 can include: (1) data associated with the virtual world in the parallel reality game (e.g., image data used to render the virtual world on a display device, geographic coordinates of locations in the virtual world, etc.); (2) data associated with users of the parallel reality game (e.g., user profiles including but not limited to user information, user experience level, user currency, current user positions in the virtual world/real world, user energy level, user preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of users, current status of game objectives, user leaderboard, etc.); (7) data associated with user actions/input (e.g., current user positions, past user positions, user moves, user input, user queries, user communications, etc.); or (8) any other data used, related to, or obtained during implementation of the parallel reality game. The game data stored in the game database 330 can be populated either offline or in real time by system administrators or by data received from users (e.g., users), such as from a client device 310 over the network 370.

In one or more embodiments, the server 320 is configured to receive requests for data from a client device 310 (for instance via remote procedure calls (RPCs)) and to respond to those requests via the network 370. The server 320 can encode data in one or more data files and provide the data files to the client device 310. In addition, the server 320 can be configured to receive data (e.g., user positions, user actions, user input, etc.) from a client device 310 via the network 370. The client device 310 can be configured to periodically send user input and other updates to the server 320, which the server uses to update data in various databases, e.g., updating game data in the game database 330 to reflect any and all changed conditions for the game.

In the embodiment shown in FIG. 3, the server 320 includes a universal game module 322, a commercial game module 323, a data collection module 324, an event module 326, a mapping system 327, a calibration module 328, and a map store 329. As mentioned above, the server 320 interacts with a game database 330 that may be part of the game server or accessed remotely (e.g., the game database 330 may be a distributed database accessed via the network 370). In other embodiments, the server 320 contains different or additional elements. In addition, the functions may be distributed among the elements in a different manner than described.

In gaming embodiments, the universal game module 322 hosts an instance of the parallel reality game for a set of users (e.g., all users of the parallel reality game) and acts as the authoritative source for the current status of the parallel reality game for the set of users. As the host, the universal game module 322 generates game content for presentation to users (e.g., via their respective client devices 310). The universal game module 322 may access the game database 330 to retrieve or store game data when hosting the parallel reality game. The universal game module 322 may also receive game data from client devices 310 (e.g., depth information, user input, user position, user actions, landmark information, etc.) and incorporates the game data received into the overall parallel reality game for the entire set of users of the parallel reality game. The universal game module 322 can also manage the delivery of game data to the client device 310 over the network 370. In some embodiments, the universal game module 322 also governs security aspects of the interaction of the client device 310 with the parallel reality game, such as securing connections between the client device and the server 320, establishing connections between various client devices, or verifying the location of the various client devices 310 to prevent users cheating by spoofing their location.

In gaming embodiments, the commercial game module 323 can be separate from or a part of the universal game module 322. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 manages various functionality (e.g., in the parallel reality game) associated with a data collection activity in the real world. For instance, the data collection module 324 can modify game data stored in the game database 330 to include game features linked with data collection activity in the parallel reality game. The data collection module 324 can also analyze data collected by users pursuant to the data collection activity and provide the data for access by various platforms.

The event module 326 manages user access to events, e.g., in the parallel reality game. Although the term “event” is used for convenience, it should be appreciated that this term need not refer to a specific event at a specific location or time. Rather, it may refer to any provision of access-controlled game content where one or more access criteria are used to determine whether users may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one or more embodiments, the mapping system 327 stores the 3D map along with any semantic/contextual information in the map store 329. The 3D map may be stored in the map store 329 in conjunction with location information (e.g., GPS coordinates of the center of the 3D map, a ringfence defining the extent of the 3D map, or the like). Thus, the server 320 can provide the 3D map to client devices 310 that provide location data indicating they are within or near the geographic area covered by the 3D map.

In one or more embodiments, the calibration module 328 performs extrinsic calibration of the camera assembly 312 and the LiDAR sensor 313. The calibration module 328 receives image data including one image captured by a camera (e.g., of the camera assembly 312) and LiDAR data including a point cloud captured by a LiDAR (e.g., the NRS solid state LiDAR 313). The calibration module 328 identifies markers or other key features in the image captured by the camera. The calibration module 328 filters and segments the point cloud into planes. For each plane, the calibration module 328 collects connected points within a threshold of the plane. The calibration module 328 projects the points into the detected plane to identify holes and to decode the markers. If, in a given plane, the markers or key features are recognized, the calibration module 328 can determine the pose of the identified markers (e.g., of a calibration target). The calibration module 328 may implement a two-dimensional optimization step. If the marker identification stage fails at a plane, the calibration module 328 iterates to the next larger plane and repeats the marker identification step. This process may be repeated for any number of camera-LiDAR frames. The calibration module 328 determines the transformation (i.e., the extrinsic calibration) between the LiDAR pose and the camera pose based on aggregation of information on the identified markers between the camera-LiDAR frames. The calibration module 328 may perform the extrinsic calibration with any other camera-LiDAR pairings.

Additional details relating to camera-LiDAR extrinsic calibration with the above methodology are described in the attached document entitled “60025 Appendix to the Specification.”The network 370 can be any type of communications network, such as a local area network (e.g., an intranet), wide area network (e.g., the internet), or some combination thereof. The network can also include a direct connection between a client device 310 and the server 320. In general, communication between the server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Pose Calibration of Lidar Sensor & Camera

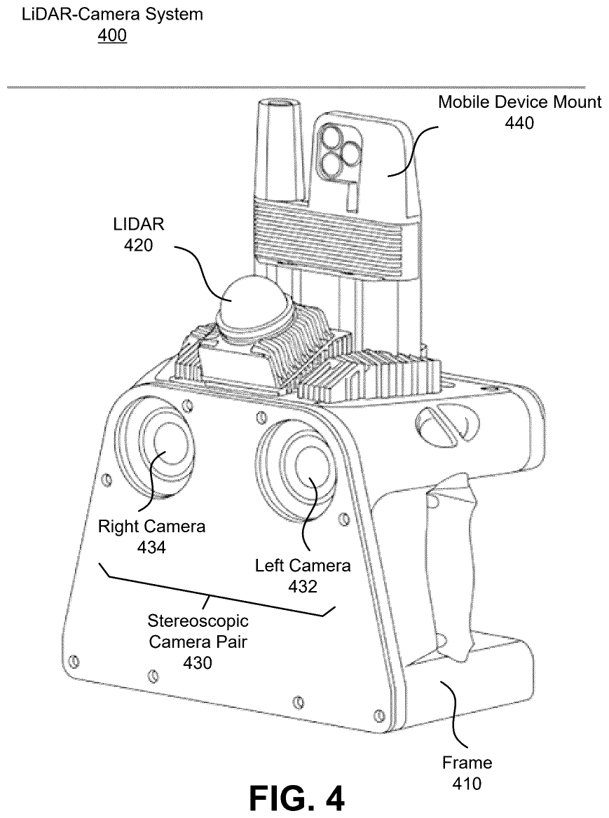

FIG. 4 is an example LiDAR-camera system 400, according to one embodiment. The LiDAR-camera system 400 has a LiDAR sensor 420 and a stereoscopic camera pair 430 mounted to a frame 410. The mounting may be fixed and rigid, such that the LiDAR sensor 420 and the stereoscopic camera pair 430 cannot translate or rotate relative to the frame 410, i.e., with the aim of preserving precise geometry between sensors. In other embodiments, the LiDAR sensor 420, the stereoscopic camera pair 430, or some combination thereof may be mounted on actuators for controlling a position, or an orientation of each sensor. The LiDAR-camera system 400 may, optionally, include a mobile device mount 440, where a mobile device may be mounted, e.g., to serve as a user interface, data logger, or compute platform. The LiDAR-camera system 400 may also include other components for controlling operation of the sensors, for power regulation, and for interfacing with a host computer or mobile device. Prior to operation, the LiDAR-camera system 400 can be calibrated for intrinsics (per-camera lens parameters) and extrinsics (relative poses between LiDAR and cameras), and is often time-synchronized using hardware triggers or a shared clock. During use, the LiDAR produces a three-dimensional (3D) point cloud, while the stereoscopic camera pair produces image data. The data captured by the LiDAR-camera system 400 can be used in a fusion pipeline that projects LiDAR points into the image planes for colorization, or uses LiDAR depth to perform robust mapping, scene understanding, augmented reality tasks, robotics tasks, autonomous navigation, or other applications that may rely on LiDAR data and image data.

The LiDAR sensor 420 captures depth information in an environment surrounding the LiDAR sensor 420. In one or more embodiments, the LiDAR sensor 420 comprises a light source (typically a pulsed laser diode at 905 nm or a fiber laser around 1550 nm), beam-shaping optics, a scanning mechanism (e.g., a MEMS mirror or rotating module) or solid-state steering, a receiver path with a photodetector, an optical bandpass filter to reject ambient light, and readout electronics including a transimpedance amplifier, analog-to-digital conversion, and precise timing circuitry (time-to-digital converter). Other embodiments may include additional, fewer, or different components. In embodiments employing pulsed time-of-flight operation, nanosecond-scale laser pulses are emitted into the scene; returned photons reflected from surfaces are detected, and the round-trip time is converted to range. Multiple samples per beam and range gating improve signal-to-noise, while intensity/reflectivity is recorded from return amplitude. The scanner sweeps a 2D field of view to build a point cloud with XYZ and intensity. In embodiments with a non-repetitive scanning solid-state LiDAR, the LiDAR sensor 420 is configured to emit short laser pulses and to steer each shot to a different angle following a pseudo-random or quasi-Lissajous trajectory rather than a fixed raster. This injected randomization avoids having the beam trace the exact same path within a frame, such that coverage densifies over multiple frames. Onboard firmware performs pulse detection, outlier rejection, temperature compensation, and range calibration; synchronization I/O (trigger in/out, PPS) aligns captures with the cameras. The final data are timestamped and streamed to the host for registration and fusion.

The stereoscopic camera pair 430 includes two matched cameras at a fixed relative position and relative orientation to one another, i.e., left camera 432 and right camera 434. The stereoscopic camera pair 430 can be mounted on a rigid bar. Each camera of the stereoscopic camera pair 430 may include a lens assembly, an image sensor (e.g., often a global shutter to minimize motion artifacts), and hardware for shared trigger to ensure simultaneous exposure.

After factory or field calibration to estimate each camera's intrinsics and the stereoscopic extrinsics, images can be rectified so corresponding epipolar lines align horizontally. In one or more example applications, stereo matching (e.g., block matching or semi-global matching) computes disparity between the left and right images, which is converted to depth. Exposure and gain can be synchronized across the two cameras to balance image quality across views, and rolling mechanical or electronic shutters are avoided when possible to reduce disparity errors. Fused with LiDAR, stereo provides dense detail while LiDAR supplies precise scale and depth in low-texture or low-light regions.

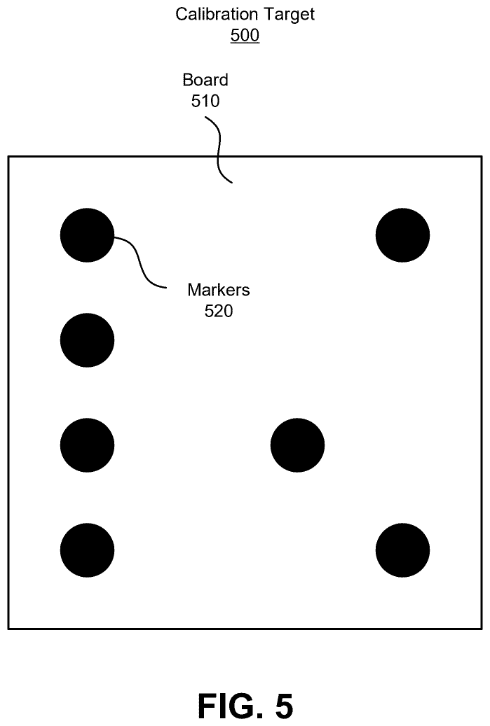

FIG. 5 is an example calibration target 500, i.e., for use in pose calibration of a LiDAR sensor and a camera, according to one embodiment. The calibration target 500 is a board 510 with a high-reflectance background (e.g., matte white) and a set of low-reflectance markers 520 (e.g., matte black paint or vinyl) laid out in a known two-dimensional pattern, e.g., to enable extrinsic pose calibration between a stereoscopic camera pair and a LiDAR sensor. The contrast empowers the stereoscopic camera pair to detect the marker centroids and edges reliably under varied lighting. The low-reflectance markers creates distinct holes in the point clouds captured by the LiDAR sensor. The holes are discontinuities, where an emitted light beam by the LiDAR sensor does not reflect back to the photodetector. The planar form of the background 510 empowers robust plane fitting, when aiming to calibrate extrinsics of the stereoscopic camera pair and the LiDAR sensor.

In one or more embodiments, the marker pattern is intentionally asymmetric to remove orientation ambiguities: four linear markers are evenly spaced along the left-hand side, two additional markers occupy the right-hand corners, and a final marker is placed between the lower-right corner marker and the geometric center of the target. The markers are typically simple shapes (e.g., circles or squares) with accurately surveyed centers defined in the target's coordinate frame, and the board surface is flat to within tight tolerances so the LiDAR can estimate a stable plane normal and offset. During calibration, multiple observations from different viewpoints are captured; the LiDAR fits a plane to the board and optionally extracts marker edges from intensity, while the stereo system detects the marker set and rectifies images to subpixel accuracy. A joint optimization then solves for the rigid transform between sensors by minimizing both point-to-plane errors (LiDAR plane to camera rays) and reprojection errors (known marker coordinates to image detections), yielding a scale-consistent, repeatable extrinsic. Practical details include a matte finish to suppress glare, fiducial sizes chosen to be resolvable by the cameras at working distance and large enough to produce measurable LiDAR intensity contrast, and printed or engraved reference dimensions to verify target integrity over time.

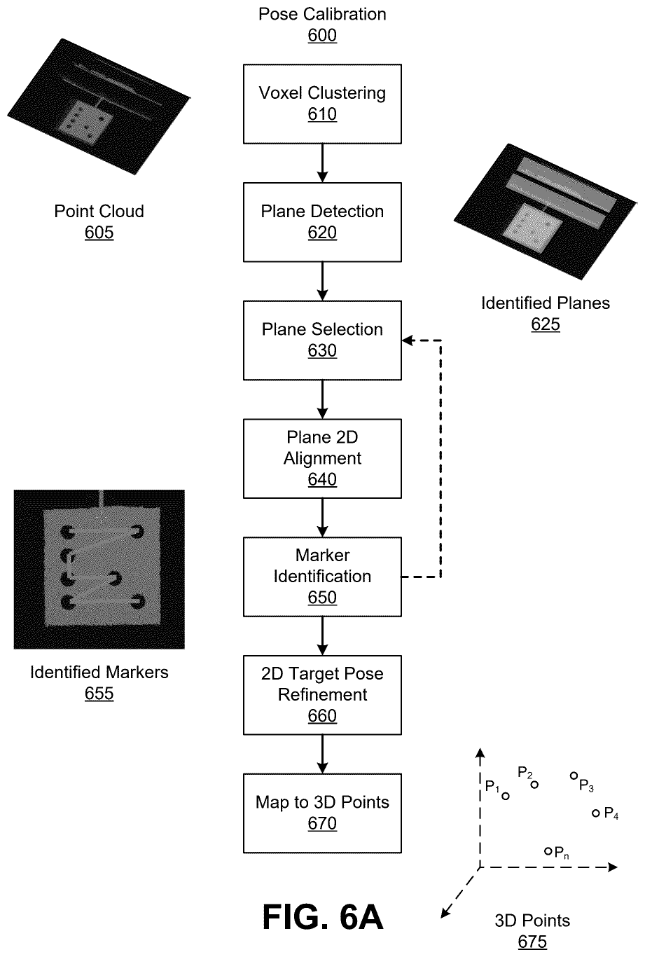

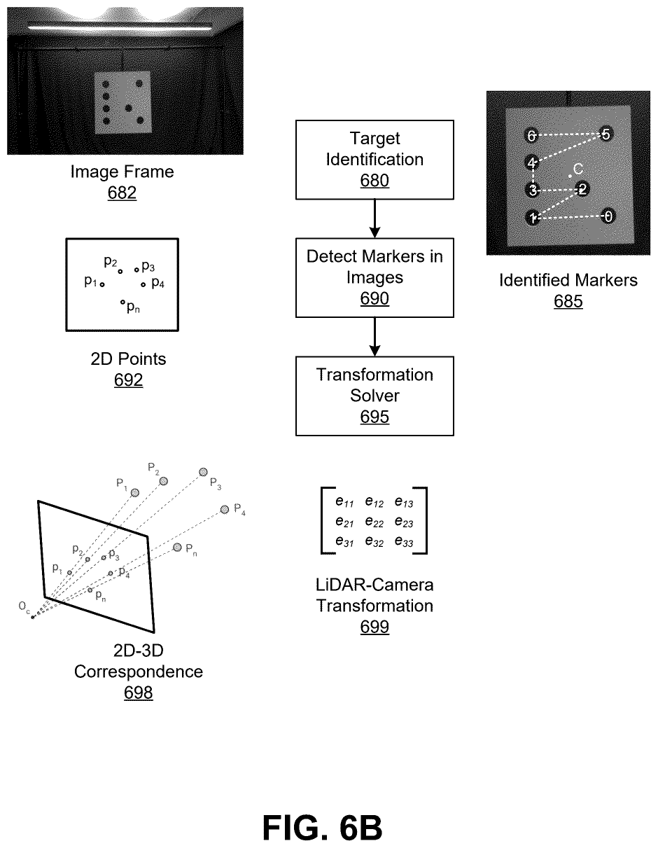

FIG. 6A is a conceptual workflow describing pose calibration 600 of a LiDAR sensor and a camera, according to one embodiment. The calibration module 328 of the game server 320 performs the LiDAR-camera pose calibration 600. In other embodiments, another device has the functionality of the calibration module 328, capable of performing the LiDAR-camera pose calibration.

The calibration module 328 receives the point cloud 605 captured by the LiDAR sensor. The calibration module 328 performs marker identification from the point cloud 605. The calibration module 328 performs voxel clustering 610. Voxel clustering entails grouping points in the point cloud together to form distinct surfaces. The calibration module 328 can use a seed voxel, then incrementally gather neighboring voxels with sufficient density of points. Neighboring voxels that have point density below a threshold do not get added into the cluster. This process helps to identify boundaries of the planes and also helps to reduce noise of the dense point cloud.

The calibration module 328 performs plane detection 620 from the clustered voxels. The calibration module 328 can filter out or exclude clustered points that do not have planar geometry. The identified planes 625 can be disparately oriented, as the calibration module 328 may not have knowledge about placement of the calibration target within the environment. As such, the calibration module 328 goes about plane detection and selection to identify the appropriate set of points in the point cloud pertaining to the calibration target.

Of the identified planes 625, the calibration module 328 performs plane selection 630 to select the appropriate set of points in the point cloud pertaining to the calibration target. In some embodiments, the calibration module 328 can select the plane that best matches known dimensions of the calibration target. For example, if the calibration target is square, the calibration module 328 can apply that information in the plane selection 630, to filter out planes that are not square in shape. In other embodiments, the calibration module 328 can start with the largest plane.

The calibration module 328 performs plane 2D alignment 640 by mapping the points of the selected plane into a 2D grid. The calibration module 328 may further rotate the points in the 2D grid, to orient the plane in a rectilinear configuration. The calibration module 328 tracks the transformation from the 3D coordinate system to the 2D grid.

The calibration module 328 performs marker identification 650 from the points mapped onto the 2D grid. The calibration module 328 identifies holes in the points. The calibration module 328 may identify the holes knowing the spatial configuration of the makers in the calibration target. For example, between each pair of markers, the calibration module 328 may know the relative distances and angles. If the calibration module 328 fails to identify holes sufficient to the markers, the calibration module 328 can iterate to the next plane, e.g., the next largest plane. The result of the marker identification 650 is the identified markers 655.

The calibration module 328 may perform a 2D target pose refinement 660. The calibration module 328 refines the transformation that mapped the 3D points onto the 2D grid. This refinement boosts accuracy and precision in backprojecting the identified markers 655 from the 2D grid back into the 3D coordinate system.

The calibration module 328 maps 670 the identified markers 655 to the 3D points 675. The calibration module 328 maps the identified markers 655 from the 2D grid based on the refined transformation.

FIG. 6B is a continuation of the conceptual workflow describing the LiDAR-camera pose calibration 600 shown in FIG. 6A, according to one embodiment.

The calibration module 328 performs target identification 680 in the image frame 682. The calibration module 328 may use computer vision algorithms, e.g., a feature identification algorithm or model to identify the makers 685 from the image frame 682. In some embodiments, the feature identification model is an image-based machine-learning model, e.g., a convolutional neural network. The calibration module 328 may identify the markers 685 further informed by the spatial configuration of the markers.

In one or more embodiments, the calibration module 328 may perform the pose calibration between the LiDAR sensor and an array of cameras, e.g., a stereoscopic camera pair. In such embodiments, the calibration module 328 can detect markers 690 across images taken by the cameras in the array. Each set of identified markers are grouped as 2D points 692.

The calibration module 328 applies a transformation solver 695 to determine the LiDAR-camera pose transformation 699 satisfying the 2D-3D correspondence 698 of the identified markers from the two different modalities. In some embodiments, the calibration module 328 applies a Perspective-n-Point algorithm to solve the transformation. In some embodiments, the calibration module 328 solves the transformations across multiple cameras at the same time. This can entail constraining the solving based on the relative poses between the cameras in the array. In other embodiments, the transformation solver 695 can solve all relative poses between all pairs of sensors at the same time, though may solve a subset of all possible pairings. For example, with a stereoscopic camera pair (consisting of two cameras) and a LiDAR sensor, the calibration module 328 determines a pose transformation between the first camera and the LiDAR sensor, a pose transformation between the second camera and the LiDAR sensor, and a pose transformation between the two cameras. This principle can be extended to arrays of cameras with 3, 4, 5, 6, 7, 8, 9, or 10 cameras.

### Example Method

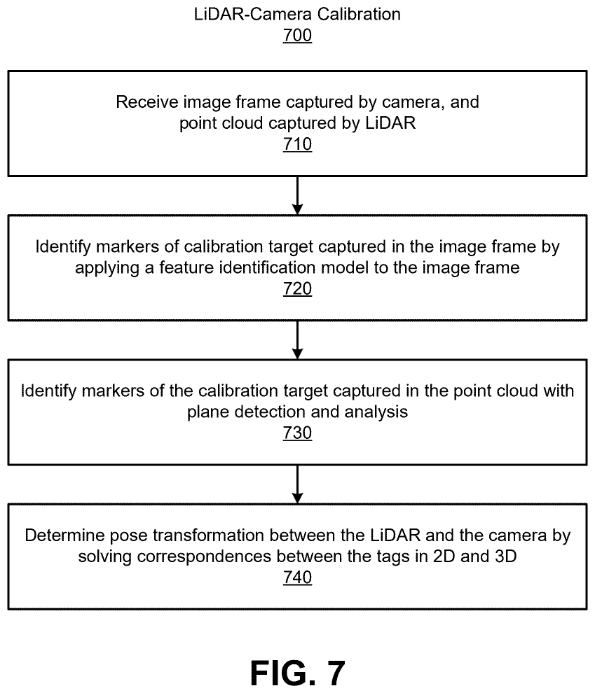

FIG. 7 is a flowchart describing the process of LiDAR-camera pose calibration 700, according to one embodiment. A system is described as performing the LiDAR-camera pose calibration 700. For example, the game server 320, or more specifically the calibration module 328, may perform the LiDAR-camera pose calibration 700. In other embodiments, the LiDAR-camera pose calibration 700 comprises additional, fewer, or different steps than those listed.

The system receives 710 an image frame captured by the camera mounted on a device and a point cloud captured by the LiDAR sensor mounted on the device. The LiDAR sensor has an overlapping field of view with the camera. The camera may be part of a stereoscopic camera pair mounted on the device. The system may perform the LiDAR-pose calibration between each camera of the stereoscopic camera pair and the LiDAR sensor. In some embodiments, the system may perform the calibration for one camera further base the pose transformation between the pair of cameras. The LiDAR sensor may be a non-repetitive scanning solid state LiDAR sensor.

The system identifies 720 markers of a calibration target captured in the image frame by applying a feature identification model to the image frame.

The system identifies 730 the markers of the calibration target captured in the point cloud with plane detection and analysis. The system may identify the markers by first identifying planes, which may entail clustering points in the point cloud into one or more planes. The system may cluster the points in the point cloud by: performing a voxel growing approach to incrementally capture points into one cluster of points; and identifying the one or more planes from the clusters of points. From the identified planes, the system selects one of the planes based on sizes of the planes. The system may select the plane of largest size. The system may identify holes in the selected plane as the markers of the calibration target. The system may identify the holes by projecting points clustered in the selected plane into a two-dimensional grid, then identifying the holes in the 2D grid. The system may identify the holes knowing the spatial configuration of the markers in the calibration target. Upon identifying the holes in the 2D gride, the system can project the markers back into the three-dimensional coordinate system of the point cloud, in the process, determining three-dimensional coordinates for each marker in the three-dimensional coordinate system.

The system determines 740 a pose transformation between the camera and the LiDAR sensor based on information identifying the markers from the image frame and information identifying the markers from the point cloud. The system may determine the pose transformation between the camera and the LiDAR sensor based on intrinsic parameters of the camera. The computer-implemented method of clause 1, wherein determining the pose transformation comprises performing a Perspective-n-Point algorithm with the markers in the image frame and the markers in the point cloud to determine the pose transformation.

### Example Applications of Calibration Lidar and Camera Sensors

With accurate extrinsic calibration between the LiDAR and camera, sensor fusion improves perception and scene understanding. LiDAR point clouds can be projected into the image plane for colorization and semantic labeling, while image-derived masks can be back-projected into the 3D coordinate system to segment the point cloud. This can yield a metrically accurate, semantically rich 3D representation that boosts object detection, drivable space estimation, and obstacle classification in cluttered or low-texture environments.

For dense 3D mapping and reconstruction, a calibrated LiDAR-camera rig produces accurate point clouds aligned with high-resolution imagery. This enables textured meshes and photorealistic digital twins. LiDAR provides scale and geometry, while the camera supplies color and fine surface detail, supporting multi-session map merging and long-term change detection.

In localization and SLAM, pose calibration empowers both modalities (LiDAR point clouds and image data from the camera) to contribute to a single state estimate. LiDAR odometry supplies strong geometric constraints, while visual features improve loop closure and place recognition. The combined system reduces drift and increases robustness in low light, repetitive structures, or foliage.

For autonomous navigation, the point cloud data from the LiDAR sensor delivers reliable range and free-space boundaries, while image data from the camera can be used to recognize pedestrians, signage, and lane markings. Pose calibration aligns semantic cues with 3D obstacles, improving path planning, collision avoidance, and intent prediction. This leads to safer, more efficient autonomous behavior.

In augmented reality applications, extrinsic calibration allows virtual content to be placed at true scale using LiDAR geometry while maintaining visual alignment with camera imagery. LiDAR-derived depth provides robust occlusion and collision handling, especially in low-texture or low-light areas where monocular depth fails. This improves realism and stability of overlays.

For dataset creation, labeling, and self-supervision, calibrated pairs enable label transfer between modalities. Image semantic masks can annotate 3D points, and LiDAR clusters can generate image bounding boxes, reducing manual labeling. They also produce high-quality depth ground truth for training and validating perception models. For example, in training an image-based depth estimation model, the training system can leverage paired image data and point cloud data. Precision in the pose calibration empowers the training system to leverage the two modalities, without loss of accuracy.

### Example General Computing System

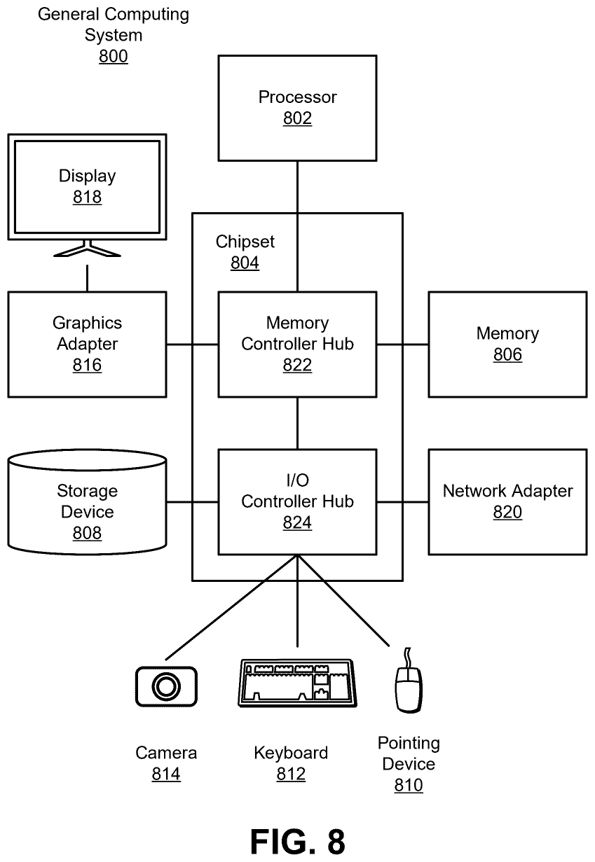

FIG. 8 is a block diagram of a general computing system, according to one embodiment. The example computer 800 may be suitable for use as a client device 310 or game server 320. The example computer 800 includes at least one processor 802 coupled to a chipset 804. References to a processor (or any other component of the computer 800) should be understood to refer to any one such component or combination of such components working cooperatively to provide the described functionality. The chipset 804 includes a memory controller hub 822 and an input/output (I/O) controller hub 824. A memory 806 and a graphics adapter 820 are coupled to the memory controller hub 822, and a display 818 is coupled to the graphics adapter 820. A storage device 808, a pointing device 810, a keyboard 812, a camera 814, and network adapter 820 are coupled to the I/O controller hub 824. Other embodiments of the computer 800 have different architectures, e.g., additional, fewer, or different components than those listed.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 810 is a mouse, track ball, touchscreen, or other type of pointing device, and may be used in combination with the keyboard 812 (which may be an on-screen keyboard) to input data into the computer system 800. The camera 814 includes a lens assembly and an image sensor. The lens assembly focuses external light to be incident on the image sensor, which converts the incident light into a digital signal representative of an image. The graphics adapter 816 displays images and other information on the display 818. The network adapter 820 couples the computer system 800 to one or more computer networks, such as network 370.

The types of computers used by the entities of FIGS. 3 and 4 can vary depending upon the embodiment and the processing power required by the entity. For example, the game server 320 might include multiple blade servers working together to provide the functionality described. Furthermore, the computers can lack some of the components described above, such as keyboards 810, graphics adapters 812, and displays 818.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one or more embodiments” or “an embodiment” means that a particular element, feature, structure, or characteristic described in connection with the embodiment is included in at least one or more embodiments. The appearances of the phrase “in one or more embodiments” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method for performing extrinsic calibration between a camera and a light detection and ranging (LiDAR) sensor, the method comprising:
receiving an image frame captured by the camera mounted on a device;
receiving a point cloud captured by the LiDAR sensor mounted on the device, the LiDAR sensor having an overlapping field of view with the camera;
identifying markers of a calibration target captured in the image frame by applying a feature identification model to the image frame;
identifying the markers of the calibration target captured in the point cloud by:
clustering points in the point cloud into one or more planes;
selecting one of the planes based on sizes of the planes; and
identifying holes in the selected plane as the markers of the calibration target; and
determining a pose transformation between the camera and the LiDAR sensor based on information identifying the markers from the image frame and information identifying the markers from the point cloud.

2. The computer-implemented method of claim 1, wherein determining the pose transformation between the camera and the LiDAR sensor is further based on intrinsic parameters of the camera.

3. The computer-implemented method of claim 1, wherein the camera is part of a stereoscopic camera pair mounted on the device.

4. The computer-implemented method of claim 1, wherein the LiDAR sensor is a non-repetitive scanning solid state LiDAR sensor.

5. The computer-implemented method of claim 1, wherein identifying the markers of the calibration target captured in the point cloud further comprises:
projecting points clustered in the selected plane into a two-dimensional grid; and
identifying the holes in the projected points.

6. The computer-implemented method of claim 1, wherein identifying the markers of the calibration target captured in the point cloud further comprises:
projecting the markers into three-dimensional coordinate system of the point cloud;
determining three-dimensional coordinates for each marker in the three-dimensional coordinate system.

7. The computer-implemented method of claim 1, wherein clustering the points in the point cloud into one or more planes comprises:
performing a voxel growing approach to incrementally capture points into one cluster of points; and
identifying the one or more planes from the clusters of points.

8. The computer-implemented method of claim 1, wherein selecting one of the planes sized to match the calibration target comprises selecting the plane of largest size.

9. The computer-implemented method of claim 1, wherein identifying the holes in the selected plane as the markers of the calibration target comprises identifying the holes informed by a spatial configuration of the markers in the calibration target.

10. The computer-implemented method of claim 1, wherein determining the pose transformation comprises performing a Perspective-n-Point algorithm with the markers in the image frame and the markers in the point cloud to determine the pose transformation.

11. A system for performing extrinsic calibration between a camera and a light detection and ranging (LiDAR) sensor, the system comprising:
a processor; and
a non-transitory computer-readable storage medium storing instructions that, when executed by the processor, cause the processor to perform operations comprising:
receiving an image frame captured by the camera mounted on a device;
receiving a point cloud captured by the LiDAR sensor mounted on the device, the LiDAR sensor having an overlapping field of view with the camera;
identifying markers of a calibration target captured in the image frame by applying a feature identification model to the image frame;
identifying the markers of the calibration target captured in the point cloud by:
clustering points in the point cloud into one or more planes;
selecting one of the planes based on sizes of the planes; and
identifying holes in the selected plane as the markers of the calibration target; and
determining a pose transformation between the camera and the LiDAR sensor based on information identifying the markers from the image frame and information identifying the markers from the point cloud.

12. The system of claim 11, wherein determining the pose transformation between the camera and the LiDAR sensor is further based on intrinsic parameters of the camera.

13. The system of claim 11, wherein the camera is part of a stereoscopic camera pair mounted on the device.

14. The system of claim 11, wherein the LiDAR sensor is a non-repetitive scanning solid state LiDAR sensor.

15. The system of claim 11, wherein identifying the markers of the calibration target captured in the point cloud further comprises:
projecting points clustered in the selected plane into a two-dimensional grid; and
identifying the holes in the projected points.

16. The system of claim 11, wherein identifying the markers of the calibration target captured in the point cloud further comprises:
projecting the markers into three-dimensional coordinate system of the point cloud;
determining three-dimensional coordinates for each marker in the three-dimensional coordinate system.

17. The system of claim 11, wherein clustering the points in the point cloud into one or more planes comprises:
performing a voxel growing approach to incrementally capture points into one cluster of points; and
identifying the one or more planes from the clusters of points.

18. The system of claim 11, wherein selecting one of the planes sized to match the calibration target comprises selecting the plane of largest size.

19. The system of claim 11, wherein identifying the holes in the selected plane as the markers of the calibration target comprises identifying the holes informed by a spatial configuration of the markers in the calibration target.

20. The system of claim 11, wherein determining the pose transformation comprises performing a Perspective-n-Point algorithm with the markers in the image frame and the markers in the point cloud to determine the pose transformation.
